(19) United States
(12) Patent Application Publication
(10) Pub. No.: US 2021/0107146 A1
(43) Pub. Date: Apr. 15, 2021

(54) GIMBAL CONTROL METHOD AND GIMBAL

(71) Applicant: SZ DJI TECHNOLOGY CO., LTD., Shenzhen (CN)

(72) Inventor: Tie SU, Shenzhen (CN)

(73) Assignee: SZ DJI TECHNOLOGY CO., LTD., Shenzhen (CN)

(21) Appl. No.: 17/031,858

(22) Filed: Sep. 24, 2020

Related U.S. Application Data
(63) Continuation of application No. PCT/CN2018/085123, filed on Apr. 28, 2018.

(51) Int. Cl. B25J 9/16; F16M 11/18; F16M 11/12; B25J 9/04; B25J 19/02; G05B 19/4155; G01C 21/18; G05D 1/00

(52) U.S. Cl. CPC B25J 9/1615; F16M 11/18; F16M 11/123; B25J 9/045; B25J 9/1607; G03B 17/561; G05B 19/4155; G01C 21/18; G05D 1/0094; G05B 2219/40269; B25J 19/02

(57) ABSTRACT

The present disclosure provides a gimbal, a gimbal control device and method implemented in the gimbal and gimbal control device. The method includes obtaining a first angular velocity of a directional device mounted on a gimbal in a first direction; obtaining at least one reference angular velocity in at least one reference direction of the gimbal; obtaining an angular velocity offset in the first direction based on the first angular velocity and the at least one reference velocity; and adjusting an angle of the gimbal in the first direction based on the angular velocity offset. In this way, the posture drift of the gimbal in the yaw direction due to a detection error of the directional device may be eliminated, so that the picture taken by a photographing device provided on gimbal is stable, and the shooting quality is improved.

### RELATED APPLICATIONS

This application is a continuation application of PCT application No. PCT/CN2018/085123, filed on Apr. 28, 2018, and the contents of which are incorporated herein by reference in their entirety.

### TECHNICAL FIELD

The present application relates to the technical field of gimbals, and in particular, to a gimbal control method and a gimbal.

### BACKGROUND

A gimbal can carry a load. A stabilized gimbal can stabilize the posture of a load carried thereon, that is, maintain the posture of the load in a stationary state when the gimbal is moving. In addition, a stabilized gimbal can control the movement of the load. For example, in the case where the load is a photographing device, after the photographing device is mounted on the stabilized gimbal, the stabilized gimbal can stabilize the shooting direction of the photographing device to ensure that the photographing device can shoot stable pictures while moving.

Three motors are provided on a support arm of a stabilized gimbal to control the rotation of the stabilized gimbal in pitch, roll and yaw directions. Moreover, the stabilized gimbal is also equipped with a gyroscope to sense the angular velocity of the stabilized gimbal in the aforementioned three directions. The angular velocity can be used to accurately control the rotation of the stabilized gimbal. However, the gyroscope can be easily influenced by the Earth's rotation, thus the angular velocity sensed by the gyroscope may drift, causing drifting of the posture of the stabilized gimbal. This may further cause drifting of the captured image and thus affect the shooting quality. Therefore, an acceleration sensor is further provided on the stabilized gimbal. The acceleration sensor can sense the acceleration of the stabilized gimbal in the pitch and roll directions, based on which the drifting of the stabilized gimbal in the pitch and roll directions may be eliminated. Moreover, the drifting of the stabilized gimbal in the yaw direction may also be eliminated by a compass provided on the stabilized gimbal.

However, a compass can accurately eliminate the drifting only when there is no interference of a magnetic field. If the working environment of a stabilized gimbal is complex, there may be certain interference from a magnetic field, which may prevent the drifting in the yaw direction from being eliminated. This may result in capturing unstable pictures, thereby affecting the shooting quality.

### SUMMARY

The present application provides a gimbal control method and a gimbal, some examples of which can be used to eliminate the posture drifting of the gimbal in the yaw direction caused by a detection error of a directional device, such as a gyroscope, so that a photographing device mounted on the gimbal can take stable pictures, and the shooting quality is thus improved.

In a first aspect, some embodiments of the present application provide a gimbal control device, comprising: at least one storage medium, including a set of instructions for gimbal control; at least one processor in communication with the at least one storage medium, wherein during operation, the at least one processor executes the set of instructions to: obtain a first angular velocity of a directional device mounted on a gimbal in a first direction; obtain at least one reference angular velocity in at least one reference direction of the gimbal; obtain an angular velocity offset in the first direction based on the first angular velocity and the at least one reference angular velocity; and adjust an angle of the gimbal in the first direction based on the angular velocity offset.

According to some embodiments of the present application, the directional device includes a gyroscope, and the first angular velocity includes an angular velocity detected by the gyroscope.

According to some embodiments of the present application, to obtain the angular velocity offset in the first direction, the at least one processor further executes the set of instructions to: obtain a second angular velocity by mapping one of the at least one reference angular velocity to the first direction; and obtain the angular velocity offset in the first direction based on the first angular velocity and the second angular velocity.

According to some embodiments of the present application, the first direction includes at least one of a yaw direction, a roll direction, or a pitch direction of the gimbal; and the at least one reference angular velocity includes at least one of: an angular velocity of a pitch axis motor, which controls a pitch angle of the gimbal, an angular velocity of a roll axis motor, which controls a roll angle of the gimbal, or an angular velocity of a yaw axis motor, which controls a yaw angle of the gimbal.

According to some embodiments of the present application, to obtain the angular velocity offset, the at least one processor further executes the set of instructions to: obtain the second angular velocity by mapping the angular velocity of the yaw axis motor to the yaw direction; and obtain the angular velocity offset in the yaw direction by comparing the first angular velocity with the second angular velocity.

According to some embodiments of the present application, to obtain the second angular velocity, the at least one processor further executes the set of instructions to: obtain the second angular velocity based on a transformation matrix, and the angular velocity of the pitch axis motor, the angular velocity of the roll axis motor and the angular velocity of the yaw axis motor.

According to some embodiments of the present application, to obtain the second angular velocity, the at least one processor further executes the set of instructions to: obtain the second angular velocity by multiplying the transformation matrix by a 3*1 matrix composed of the angular velocity of the pitch axis motor, the angular velocity of the roll axis motor and the angular velocity of the yaw axis motor.

According to some embodiments of the present application, prior to the obtaining of the second angular velocity by multiplying the transformation matrix by the 3*1 matrix, the at least one processor executes the set of instructions to: determine the transformation matrix based on a rotation angle of the pitch axis motor and a rotation angle of the roll axis motor.

According to some embodiments of the present application, the transformation matrix is in a form of

$$[ \begin{matrix}cosθ & 0 & - cosϕ * sin θ \\ 0 & 1 & sinϕ \\ sinθ & 0 & cosϕ * cos θ\end{matrix} ] ;$$

and to obtain the second angular velocity by multiplying the transformation matrix by the 3*1 matrix, the at least one processor executes the set of instructions to determine the second angular velocity by multiplying [sin θ0 cos φ*cos θ] in the transformation matrix by

$$[ \begin{matrix}A \\ B \\ C\end{matrix} ] ,$$

wherein θ is the rotation angle of the pitch axis motor, φ is the rotation angle of the roll axis motor, A is the angular velocity of the pitch axis motor, B is the angular velocity of the roll axis motor, and C is the angular velocity of the yaw axis motor.

According to some embodiments of the present application, during operation, the at least one processor further executes the set of instructions to: determine a third angular velocity by mapping the angular velocity of the pitch axis motor to the pitch direction; obtain an angular velocity offset in the pitch direction based on the third angular velocity and the angular velocity in the pitch direction; and adjust a pitch angle of the gimbal based on the angular velocity offset in the pitch direction.

According to some embodiments of the present application, during operation, the at least one processor further executes the set of instructions to: determine a fourth angular velocity by mapping the angular velocity of the rolling axis motor to the rolling direction; obtain an angular velocity offset in the rolling direction based on the fourth angular velocity and the angular velocity in the rolling direction; and adjust a roll angle of the gimbal based on the angular velocity offset in the roll direction.

According to some embodiments of the present application, to adjust the angle of the gimbal in the first direction based on the angular velocity offset, the at least one processor further executes the set of instructions to: obtain an actual angular velocity of the gimbal in the first direction based on the angular velocity offset and the first angular velocity; obtain an actual angle of the gimbal in the first direction based on the actual angular velocity of the gimbal in the first direction; and adjust the angle of the gimbal in the first direction based on a target angle of the gimbal in the first direction and the actual angle of the gimbal in the first direction.

According to some embodiments of the present application, during operation, the at least one processor further executes the set of instructions to: obtain an actual angular velocity of the gimbal in the yaw direction based on the angular velocity offset and the first angular velocity; determine an actual yaw angle of the gimbal based on the actual angular velocity of the gimbal in the yaw direction; and adjust the yaw angle of the gimbal based on a target yaw angle and the actual yaw angle of the gimbal.

According to some embodiments of the present application, during operation, the at least one processor further executes the set of instructions to: obtain the angular velocity of the pitch axis motor, the angular velocity of the roll axis motor and the angular velocity of the yaw axis motor respectively, based on a rotation angle of the pitch axis motor, a rotation angle of the roll axis motor and a rotation angle of the yaw axis motor.

According to some embodiments of the present application, to obtain the angular velocity of the pitch axis motor, the angular velocity of the roll axis motor, and the angular velocity of the yaw axis motor respectively, the at least one processor further executes the set of instructions to: differentiate the rotation angle of the pitch axis motor, the rotation angle of the roll axis motor and the rotation angle of the yaw axis motor respectively to obtain the angular velocity of the pitch axis motor, the angular velocity of the roll axis motor and the angular velocity of the yaw axis motor.

According to some embodiments of the present application, during operation, the at least one processor further executes the set of instructions to: obtain the rotation angle of the pitch axis motor, the rotation angle of the roll axis motor and the rotation angle of the yaw axis motor sensed by motor angle sensors.

In a second aspect, some embodiments of the present application provide a gimbal, comprising: a gyroscope; a pitch axis motor to control a pitch angle of the gimbal; a roll axis motor to control a roll angle of the gimbal; a yaw axis motor to control a yaw angle of the gimbal; and a gimbal control device communicatively connected with the gyroscope, the pitch axis motor, the roll axis motor and the yaw axis motor to: obtain a first angular velocity detected by the gyroscope, which is an angular velocity in a yaw direction, obtain an angular velocity of the pitch axis motor, an angular velocity of the roll axis motor and an angular velocity of the yaw axis motor, obtain an angular velocity offset of the gyroscope in the yaw direction according to the first angular velocity, the angular velocity of the pitch axis motor, the angular velocity of the roll axis motor, and the angular velocity of the yaw axis motor, and adjust the yaw angle of the gimbal based on the angular velocity offset.

According to some embodiments of the present application, the gimbal control device is configured to: obtain a second angular velocity based on the angular velocity of the pitch axis motor, the angular velocity of the roll axis motor and the angular velocity of the yaw axis motor; and obtain the angular velocity offset in the yaw direction based on the first angular velocity and the second angular velocity.

According to some embodiments of the present application, to obtain the second angular velocity includes to obtain the second angular velocity by mapping the angular velocity of the yaw axis motor to the yaw direction.

According to some embodiments of the present application, the gimbal control device is further configured to: obtain an actual angular velocity of the gimbal in the yaw direction based on the angular velocity offset and the first angular velocity; determine an actual yaw angle of the gimbal based on the actual angular velocity of the gimbal in the yaw direction; and adjust the yaw angle of the gimbal based on a target yaw angle and the actual yaw angle of the gimbal.

In a third aspect, some embodiments of the present application provide a gimbal control device including: a memory and a processor, and the memory is coupled to the processor; the memory may store program instructions; and the processor may be configured to call the program instructions stored in the memory to execute the gimbal control method as described in the first aspect.

In a fourth aspect, some embodiments of the present application provide a computer-readable storage medium that stores a computer program, and the computer program includes at least one piece of code that can be executed by a computer to control the computer to execute the gimbal control method as described in the first aspect.

In a fifth aspect, some embodiments of the present application provide a computer program that, when executed by a computer, executes the gimbal control method as described in the first aspect.

The program may be stored in whole or in part on a storage medium packaged with the processor, or on a storage medium not packaged with the processor. The storage medium may be, for example, a memory.

In summary, the present application provides a gimbal, a gimbal control device and a method implemented in the gimbal and the gimbal control device. The method includes obtaining a first angular velocity of the directional device mounted on the gimbal in a first direction, which may including an error due to posture drift of the directional device. The method also includes obtaining at least one reference angular velocity in at least one reference direction of the gimbal, and then mapping the at least one reference angular velocity to the first direction in order to compare the reference angular velocity and the first angular velocity. The comparison result is the angular velocity offset of the directional device. Finally, the method includes adjusting an angle of the gimbal in the first direction based on the angular velocity offset. The method helps eliminate the posture drift of the gimbal in the first direction due to a detection error of the directional device. Accordingly, the gimbal is able to work in a fixed mode for along period of time without drifting.

### BRIEF DESCRIPTION OF THE DRAWINGS

In in order to clearly explain the technical solutions of the embodiments of the present application or the existing technology, the drawings used in describing the embodiments or the existing technology will be described briefly below. Obviously, the drawings in the following description are only some embodiments of the present application. For a person of ordinary skill in the art, other drawings can be obtained based on these drawings without inventive skills involved.

FIG. 1 is a schematic architectural diagram of a gimbal according to some embodiments of the present application;

FIG. 2 is a schematic diagram of the working mechanism of a gimbal according to some embodiments of the present application;

FIG. 3 is a flowchart of a gimbal control method according to some embodiments of the present application;

FIG. 4 is a schematic structural diagram of a gimbal control device according to some embodiments of the present application; and

FIG. 5 is a schematic structural diagram of a gimbal according to some embodiments of the present application.

### DETAILED DESCRIPTION

To make the objects, technical solutions, and advantages of the embodiments of the present application clearer, the technical solutions of the embodiments of the present application will be described clearly and completely in conjunction with the accompanying drawings. Obviously, the described embodiments are a part rather than an entirety of all embodiments of the present application. Based on the embodiments of the present application, all other embodiments can be obtained by a person of ordinary skill in the art without inventive skills involved, which also fall within the scope of protection of the present application.

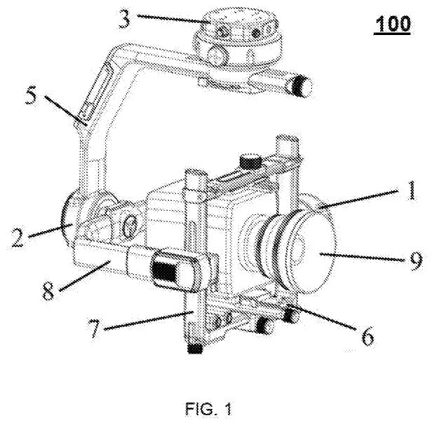

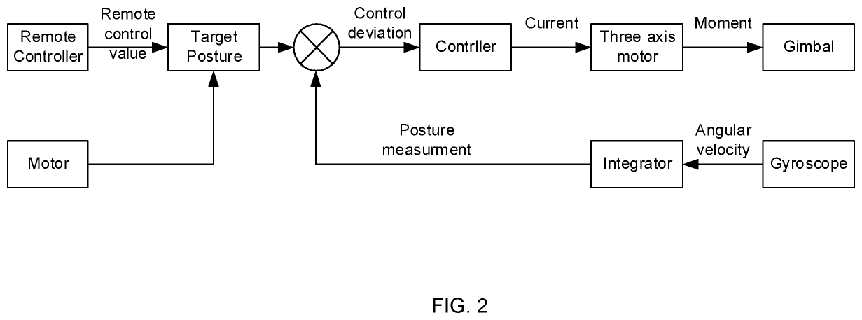

The embodiments of the present application provide a gimbal control method, a gimbal control device, and a gimbal. The gimbal may be a stabilized gimbal, and the stabilized gimbal may be applied to a mobile platform, such as a drone. FIG. 1 is a schematic architectural diagram of a gimbal according to some embodiments of the present application. As shown in FIG. 1, a gimbal may include, but is not limited to, three axis motors (including a pitch axis motor 1, a roll axis motor 2, and a yaw axis motor 3), a yaw axis arm 5, a load fixing device 6 (including an inertial measurement element), a pitch axis arm 7, a roll axis arm 8, and a load 9. In FIG. 1, as an example, the load may be a camera; the pitch axis motor 1 may be mounted on the pitch axis arm 7, the roll axis motor 2 may be mounted on the roll axis arm 8, and the yaw axis motor 3 may be mounted on the yaw axis arm 5. In addition, the gimbal may also include a gimbal base (not shown in FIG. 1). The gimbal base may be mounted above the yaw axis motor 3, and a directional device, such as a gyroscope, may be mounted to the gimbal base to assist the gimbal's intelligent following function. The working mechanism of the gimbal is illustrated in FIG. 2. The gimbal uses the inertial measurement element as a feedback device and a motor(s) as an output element to form a closed-loop control system. The control target of the control system may be the gimbal's posture, that is, for a given target posture, the measurement posture of the gimbal can reach the target posture through the feedback control. The core sensor of the gimbal may be a gyroscope. By means of conducting integration operations with the data obtained by the gyroscope, the gimbal can obtain its own posture, so as to ensure its stability in the air.

It should be understood that the naming of each component in the aforementioned gimbal is only for the purpose of identification, and should not be construed as limiting the embodiments of the present application. It should be noted that a gimbal may include all or only some of the components mentioned above.

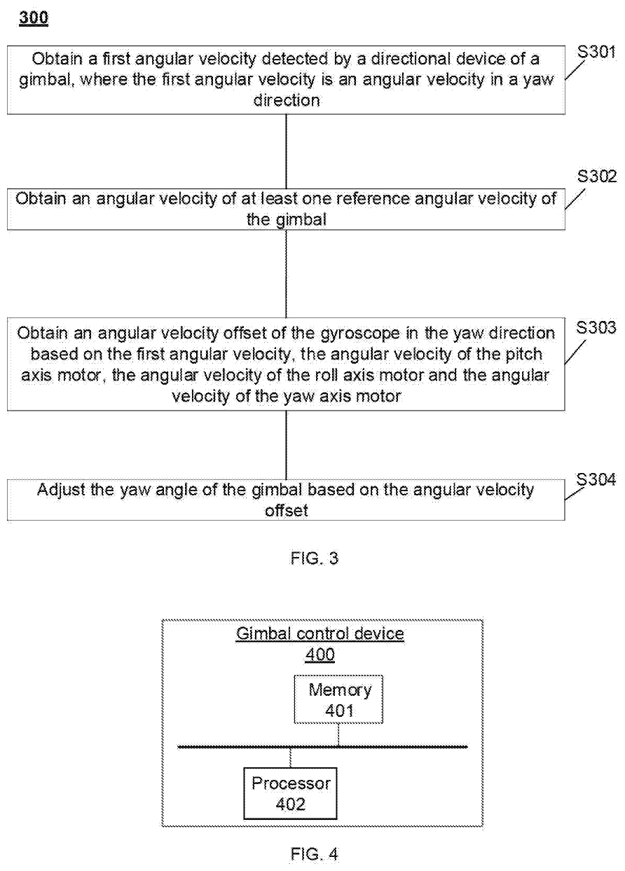

FIG. 3 is a flowchart of a gimbal control method 300 according to some embodiments of the present application. The method may be operated and/or conducted and/or executed by a gimbal control device 400 shown in FIG. 4. As shown in FIG. 3, the method some embodiments may include:

S301. Obtain a first angular velocity detected by a directional device of a gimbal, where the first angular velocity is an angular velocity in a yaw direction.

The directional device may be any device capable of sensing a direction for the gimbal. For example, the directional device may be a gyroscope, an accelerometer, a compass, or the like, which is not limited by the present application. For the purpose of illustration, the gyroscope is used herein as an example of the directional device.

In some embodiments, the gyroscope may be mounted on the gimbal base of the gimbal. During the rotation of the gimbal, the gyroscope rotates along with the gimbal, so that the gyroscope may sense an angular velocity. The gyroscope may detect an angular velocity in the yaw direction, which is herein referred to as a first angular velocity. In some embodiments, the gyroscope may also detect an angular velocity in the pitch direction and an angular velocity in the roll direction.

Accordingly, the first angular velocity detected by the gyroscope may be obtained.

S302. Obtain an angular velocity of at least one reference angular velocity of the gimbal. The reference angular velocity may be an angular velocity to calibrate the first angular velocity. For example, in scenarios where the gimbal moves in a 3-D space, the gimbal control device may need to collect angular velocities of all three coordinates in the 3-D space. Accordingly, the gimbal control device may obtain an angular velocity of the pitch axis motor, an angular velocity of the roll axis motor, and an angular velocity of the yaw axis motor of the gimbal, where the pitch axis motor may control a pitch angle of the gimbal, the roll axis motor may control a roll angle of the gimbal, and the yaw axis motor may control a yaw angle of the gimbal.

In scenarios that the gimbal moves on a 2-D plane, such as when the gimbal is mounted on a vehicle, which moves on the ground or sea, the gimbal control device may need to collect angular velocities of only two of the above-mentioned coordinates.

In scenarios that the gimbal moves along a 2-D track/road, such as when the gimbal is mounted on a train, which moves along a railway, the gimbal control device may need to collect angular velocities of only one of the above-mentioned coordinates.

For illustration purpose only, the 3-D scenario is taken as an example in describing the invention in the present application.

The rotation of the pitch axis motor in the gimbal may control the pitch angle of the gimbal, the rotation of the roll axis motor in the gimbal may control the roll angle of the gimbal, and the rotation of the yaw axis motor in the gimbal may control the yaw angle of the gimbal. In some embodiments, the angular velocity of the pitch axis motor, the angular velocity of the roll axis motor and the angular velocity of the yaw axis motor of the gimbal may be controlled.

In some embodiments, an rotation angle of the pitch axis motor, an rotation angle of the roll axis motor and an rotation angle of the yaw axis motor may be obtained firstly, and then based on the rotation angle of the pitch axis motor, the rotation angle of the roll axis motor and the rotation angle of the yaw axis motor, the angular velocity of the pitch axis motor, the angular velocity of the roll axis motor and the angular velocity of the yaw axis motor may be obtained, respectively. That is, based on the rotation angle of the pitch axis motor, the angular velocity of the pitch axis motor may be obtained; based on the rotation angle of the roll axis motor, the angular velocity of the roll axis motor may be obtained; and based on the rotation angle of the yaw axis motor, the angular velocity of the yaw axis motor may be obtained.

In some embodiments, the rotation angle of the pitch axis motor, the rotation angle of the roll axis motor and the rotation angle of the yaw axis motor may be subjected to differential processing, respectively, so as to obtain the angular velocity of the pitch axis motor, the angular velocity of the roll axis motor and the angular velocity of the yaw axis motor. That is, the rotation angle of the pitch axis motor may be subjected to differential processing to obtain the angular velocity of the pitch axis motor; the rotation angle of the roll axis motor may be subjected to differential processing to obtain the angular velocity of the roll axis motor; and the rotation angle of the yaw axis motor may be subjected to differential processing to obtain the angular velocity of the yaw axis motor.

In some embodiments, the rotation angle of a motor may be sensed by a motor angle sensor. Hence, the rotation angle of the pitch axis motor, the rotation angle of the roll axis motor and the rotation angle of the yaw axis motor sensed by the motor angle sensor(s) may be obtained. For example: three motor angle sensors may be provided to sense the rotation angle of the pitch axis motor, the rotation angle of the roll axis motor and the rotation angle of the yaw axis motor. That is, one motor angle sensor senses the rotation angle of the pitch axis motor, another motor angle sensor senses the rotation angle of the roll axis motor, and yet another motor angle sensor senses the rotation angle of the yaw axis motor. In some embodiments, the aforementioned motor angle sensors may be Hall sensors; alternatively, the aforementioned motor angle sensors may be potentiometers, or a combination thereof.

S303. Obtain an angular velocity offset of the gyroscope in the yaw direction based on the first angular velocity, the angular velocity of the pitch axis motor, the angular velocity of the roll axis motor and the angular velocity of the yaw axis motor.

In some embodiments, after the first angular velocity, the angular velocity of the pitch axis motor, the angular velocity of the roll axis motor and the angular velocity of the yaw axis motor are obtained, the angular velocity offset of the gyroscope in the yaw direction may be obtained based on the above four angular velocities.

S304. Adjust the yaw angle of the gimbal based on the angular velocity offset.

After the angular velocity offset of the gyroscope in the yaw direction is obtained through the above process, the yaw angle of the gimbal may be adjusted based on the angular velocity offset. Since the angular velocity sensed by the gyroscope has an offset in the existing technology, the gimbal's posture may drift. In the present application, based on the angular velocity of the pitch axis motor, the angular velocity of the roller motor and the angular velocity of the yaw axis motor, the angular velocity offset of the gyroscope in the yaw direction at the current first angular velocity can be accurately detected. Moreover, the posture drift of the gimbal in the yaw direction may be caused by the angular velocity offset. In this regard, the yaw angle of gimbal may be adjusted based on the angular velocity offset, which may eliminate the posture drift of the gimbal in the yaw direction.

In some embodiments, an actual angular velocity of the gimbal in the yaw direction may be firstly obtained based on the angular velocity offset and the first angular velocity, then the actual yaw angle of the gimbal may be obtained based on the actual angular velocity of the gimbal in the yaw direction; next the yaw angle of the gimbal may be adjusted based on a target yaw angle and the actual yaw angle of the gimbal.

The angular velocity detected by the gyroscope in the yaw direction (i.e., the first angular velocity) may be different from the actual angular velocity of the gimbal in the yaw direction. In some embodiments, the angular velocity offset obtained in step S303 may be used to identify this difference. Hence, based on the angular velocity offset and the first angular velocity detected by the gyroscope, the actual angular velocity of gimbal in the yaw direction may be obtained. Next, based on the actual angular velocity, the actual yaw angle of the gimbal may be obtained. For example, the actual angular velocity may be integrated to obtain the actual yaw angle. Further, the yaw angle of the gimbal may be adjusted based on the target yaw angle and the actual yaw angle of the gimbal. For example, an angular difference between the actual yaw angle and the target yaw angle may be determined based on the target yaw angle and the actual yaw angle of the gimbal. Next, the gimbal may be turned toward the yaw direction by this angular difference. For example, the rotation of the yaw axis motor may be controlled to make the gimbal turn toward the yaw direction by this angular difference. In this way, the actual yaw angle of the gimbal may be made equal to the target yaw angle.

According to the gimbal control method provided in some embodiments, the first angular velocity detected by the gyroscope in the gimbal may be obtained, which is the angular velocity in the yaw direction; the angular velocity of the pitch axis motor, the angular velocity of the roll axis motor and the angular velocity of the yaw axis motor in the gimbal are further obtained; and then the angular velocity offset of the gyroscope in the yaw direction may be obtained based on the above four angular velocities; next the yaw angle of the gimbal may be adjusted based on the angular velocity offset. In this way, the posture drift of the gimbal in the yaw direction due to a detection error of the gyroscope may be eliminated, so that stable pictures can be taken by a photographing device mounted on the gimbal, and the shooting quality is thus improved.

Through the solution of some embodiments, no matter whether the gimbal is in a locking mode or a following mode, pictures taken by the photographing device mounted on the gimbal would be stable, and the shooting quality is improved. Especially when the gimbal is in the locking mode, where the gimbal's posture remains still, by adopting the solution of some embodiments, when a still object is shot by the photographing device mounted on the gimbal, the image frames captured during the shooting are all the same, and there is no drift between the frames.

In some embodiments, step S303 may be implemented as follows: a second angular velocity may be obtained firstly based on the angular velocity of the pitch axis motor, the angular velocity of the roll axis motor and the angular velocity of the yaw axis motor, where the second angular velocity may be an angular velocity obtained by mapping the angular velocity of the yaw axis motor to the yaw direction. Next, the angular velocity offset of the gyroscope in the yaw direction may be obtained based on the first angular velocity and the second angular velocity.

Specifically, based on the angular velocity of the pitch axis motor, the angular velocity of the roll axis motor and the angular velocity of the yaw axis motor, the angular velocity of the yaw axis motor may be mapped to the yaw direction to obtain the second angular velocity. For example, the second angular velocity may be the angular velocity obtained by mapping the angular velocity of the yaw axis motor to the Z-axis of the gyroscope. Next, the angular velocity offset of the gyroscope in the yaw direction may be obtained based on the first angular velocity and the second angular velocity. For example, the first angular velocity may be subtracted from the second angular velocity, and the value obtained therefrom may be the angular velocity offset.

In some embodiments, the second angular velocity may be obtained by mapping the angular velocity of the yaw axis motor to the yaw direction through a preset matrix. Herein the preset matrix may be a transformation matrix to transform the angular velocity of the yaw axis motor to the yaw direction. Specifically, the second angular velocity may be obtained based on the present matrix (e.g., the transformation matrix), the angular velocity of the pitch axis motor, the angular velocity of the roll axis motor and the angular velocity of the yaw axis motor, that is, the angular velocity obtained by mapping the angular velocity of the yaw axis motor to the yaw direction. After the second angular velocity is obtained, the gimbal control device may compare the second angular velocity and the angular velocity in the yaw direction and obtain the difference between the two, and then treat the difference as the angular velocity offset of the gyroscope in the yaw direction.

In some embodiments, the angular velocity of the pitch axis motor, the angular velocity of the roll axis motor and the angular velocity of the yaw axis motor may be combined to form a 3*1 matrix, where the 3*1 matrix may be a matrix including 3 rows and 1 column. Next, the second angular velocity may be obtained by multiplying the present matrix (e.g., the transformation matrix) by this 3*1 matrix.

In some embodiments, the present matrix (e.g., the transformation matrix) may be related to the rotation angle of the pitch axis motor and the rotation angle of the roll axis motor. Thus, in some embodiments, prior to obtaining the second angular velocity, the present matrix (e.g., the transformation matrix) may be determined based on the rotation angle of the pitch axis motor and the rotation angle of the roll axis motor.

In some embodiments, the present matrix (e.g., the transformation matrix) may include [sin θ0 cos φ*cos θ], where θ is the rotation angle of the pitch axis motor, φ is the rotation angle of the roll axis motor. In addition, the 3*1 matrix composed of the angular velocity of the pitch axis motor, the angular velocity of the roll axis motor and the angular velocity of the yaw axis motor may be, for example:

$$[ \begin{matrix}A \\ B \\ C\end{matrix} ] ,$$

where A is the angular velocity of the pitch axis motor, B is the angular velocity of the roll axis motor, and C is the angular velocity of the yaw axis motor.

In some embodiments, [sin θ 0 cos φ*cos θ] in the present matrix (e.g., the transformation matrix) is multiplied by

$$[ \begin{matrix}A \\ B \\ C\end{matrix} ]$$

to obtain sin θ*A+0*B+cos φ*cos θ*C, and a value thereof is the second angular velocity.

It should be noted that, in some embodiments, the present matrix (e.g., the transformation matrix) may be [sin θ 0 cos φ*cos θ]. In other embodiments, [sin θ 0 cos φ*cos θ] is a row vector in the preset matrix, and the preset matrix may include other row vectors, for example, it may further include [cos θ 0−cos φ*sin θ] and [0 1 sin φ]. Hence, the preset matrix may be:

$$[ \begin{matrix}cosθ & 0 & - cosϕ * sin θ \\ 0 & 1 & sinϕ \\ sinθ & 0 & cosϕ * cos θ\end{matrix} ] .$$

Accordingly, this 3*3 present matrix may be a transformation matrix that transform the angular velocity A of the pitch axis motor, the angular velocity B of the roll axis motor, and the angular velocity C of the yaw axis motor to the first direction.

In some embodiments, the [cos θ 0−cos φ*sin θ] in the preset matrix may be multiplied by

$$[ \begin{matrix}A \\ B \\ C\end{matrix} ]$$

to obtain cos θ*A+0*B−cos φ*sin B. C, and a value thereof is a third angular velocity.

The third angular velocity may be an angular velocity obtained by mapping the angular velocity of the pitch axis motor to the pitch direction, for example, the third angular velocity may be the angular velocity obtained by mapping the angular velocity of the pitch axis motor to the Y-axis of the gyroscope. Next, the angular velocity offset of the gyroscope in the pitch direction may be obtained based on the third angular velocity and the angular velocity in the pitch direction detected by the gyroscope. For example, the gimbal control device may compare the third angular velocity and the angular velocity in the pitch direction and obtain the difference between the two, and then treat the difference as the angular velocity offset of the gyroscope in the pitch direction. Further, the pitch angle of the gimbal may be adjusted based on the angular velocity offset of the gyroscope in the pitch direction. For the specific implementation process, please refer to the above description regarding the yaw angle, which will not be described herein.

In some embodiments, [0 1 sin φ] in the present matrix (e.g., the transformation matrix) may be multiplied by

$$[ \begin{matrix}A \\ B \\ C\end{matrix} ]$$

to obtain 0*A+1*B+sin φ*C, and a value of which is a fourth angular velocity.

The fourth angular velocity is an angular velocity obtained by mapping the angular velocity of the roll axis motor to the roll direction. For example, the fourth angular velocity may be the angular velocity obtained by mapping the angular velocity of the roll axis motor to the X-axis of the gyroscope. Next, the angular velocity offset of the gyroscope in the roll direction may be obtained based on the fourth angular velocity and the angular velocity in the roll direction detected by the gyroscope. For example, the gimbal control device may compare the fourth angular velocity and the angular velocity in the roll direction and obtain the difference between the two, and then treat the difference as the angular velocity offset of the gyroscope in the roll direction. Further, the roll angle of the gimbal may be adjusted based on the angular velocity offset of the gyroscope in the roll direction. For the specific implementation process, please refer to the above description about the yaw angle, which will not be described herein.

Therefore, in some embodiments, the angular velocity offsets of the gyroscope in the pitch direction, the roll direction and the yaw direction may be obtained through the present matrix (e.g., the transformation matrix)

$$[ \begin{matrix}cosθ & 0 & - cosϕ * sin θ \\ 0 & 1 & sinϕ \\ sinθ & 0 & cosϕ * cos θ\end{matrix} ] ,$$

and then the pitch angle, the roll angle, and the yaw angle of the gimbal may be adjusted accordingly.

FIG. 4 is a schematic structural diagram of a gimbal control device provided by an embodiment of the present application. As shown in FIG. 4, the gimbal control device 400 of some embodiments may include: a memory 401 and a processor 402, and the memory 401 may be coupled to the processor 402.

The memory 401 may be one or more transitory or non-transitory storages media to store program instructions. For example, the program instructions may be one or more sets of instructions for controlling the gimbal 100. In some embodiments, the sets of instructions may be configured to instruct a processor to execute the gimbal control method 300 in FIG. 3.

The processor 402 is in communication with the memory 401. The processor 402 may be one or more hardware processors such as CPU, GPU, etc. During operation, the processor 402 may invoke the program instructions stored in the memory 401 to execute gimbal control method 300.

The gimbal control device in some embodiments may be used to execute the technical solutions of the above method embodiments, and its implementation principles and technical effects are similar to those of the method embodiments, and thus will not be repeated herein.

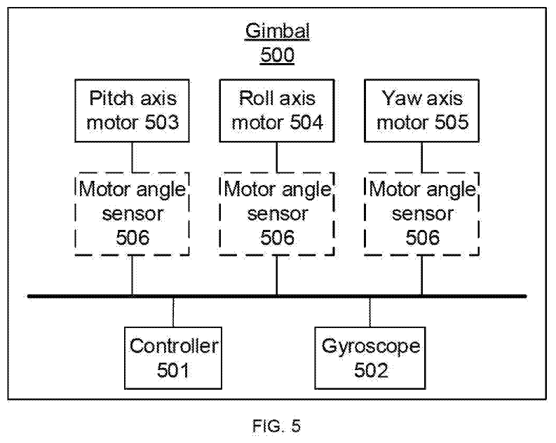

FIG. 5 is a schematic structural diagram of a gimbal provided by an embodiment of the present application. As shown in FIG. 5, the gimbal 500 of may include: a controller 501, a gyroscope 502, a pitch axis motor 503, a roll axis motor 504, and a yaw axis motor 505; the controller may be communicatively connected to the gyroscope, the pitch axis motor, the roll axis motor and the yaw axis motor.

The controller 501 may obtain a first angular velocity detected by the gyroscope 502, where the first angular velocity may be the angular velocity in the yaw direction; and obtain the angular velocity of the pitch axis motor 503, the angular velocity of the roll axis motor 504 and the angular velocity of the yaw axis motor 505, where the pitch axis motor 503 may control the pitch angle of the gimbal 500, the roll axis motor 504 may control the roll angle of the gimbal, and the yaw axis motor 505 may control the yaw angle of the gimbal 500. The angular velocity offset of the gyroscope 502 in the yaw direction may be obtained based on the first angular velocity, the angular velocity of the pitch axis motor 503, the angular velocity of the roll axis motor 504 and the angular velocity of the yaw axis motor 505. Next, the yaw angle of the gimbal 500 may be adjusted based on the angular velocity offset.

In some embodiments, the controller 501 may be specifically used for:

obtaining a second angular velocity based on the angular velocity of the pitch axis motor 503, the angular velocity of the roll axis motor 504 and the angular velocity of the yaw axis motor 505, where the second angular velocity may be the angular velocity obtained by mapping the angular velocity of the yaw axis motor 505 to the yaw direction; and obtaining the angular velocity offset of the gyroscope 502 in the yaw direction based on the first angular velocity and the second angular velocity.

In some embodiments, the controller 501 may be specifically used for obtaining the second angular velocity based on a preset matrix, the angular velocity of the pitch axis motor 503, the angular velocity of the roll axis motor 504 and the angular velocity of the yaw axis motor 505.

In some embodiments, the controller 501 may be specifically used for obtaining the second angular velocity by multiplying the preset matrix by a 3*1 matrix composed of the angular velocity of the pitch axis motor 503, the angular velocity of the roll axis motor 504 and the angular velocity of the yaw axis motor 505.

In some embodiments, prior to obtaining the second angular velocity by multiplying the preset matrix by the 3*1 matrix composed of the angular velocity of the pitch axis motor 503, the angular velocity of the roll axis motor 504 and the angular velocity of the yaw axis motor 505, the controller 501 may determine the preset matrix based on the rotation angle of the pitch axis motor 503 and the rotation angle of the roll axis motor 504.

In some embodiments, the controller 501 may be specifically used for: obtaining a value by multiplying [sin θ 0 cos φ*cos θ] in the preset matrix by

$$[ \begin{matrix}A \\ B \\ C\end{matrix} ]$$

as the second angular velocity, where θ is the rotation angle of the pitch axis motor 503, φ is the rotation angle of the roll axis motor 504, A is the angular velocity of the pitch axis motor 503, B is the angular velocity of the roll axis motor 504, and C is the angular velocity of the yaw axis motor 505.

In some embodiments, the controller 501 may be specifically used for obtaining a value by multiplying [cos θ 0−cos φ*sin θ] in the preset matrix by

$$[ \begin{matrix}A \\ B \\ C\end{matrix} ]$$

as a third angular velocity, where the third angular velocity is the angular velocity obtained by mapping the angular velocity of the pitch axis motor 503 to the pitch direction; obtaining the angular velocity offset of the gyroscope 502 in the pitch direction based on the third angular velocity and the angular velocity in the pitch direction detected by the gyroscope 502; and adjusting the pitch angle of the gimbal 500 based on the angular velocity offset of the gyroscope 502 in the pitch direction.

The controller 501 may adjust the pitch angle of the gimbal 500 by controlling the rotation of the pitch axis motor 503.

In some embodiments, the controller 501 may be specifically used for: obtaining a value by multiplying [0 1 sin φ] in the preset matrix by

$$[ \begin{matrix}A \\ B \\ C\end{matrix} ]$$

to be a fourth angular velocity, wherein the fourth angular velocity may be the angular velocity obtained by mapping the angular velocity of the roll axis motor 504 to the roll direction; obtaining the angular velocity offset of the gyroscope 502 in the rolling direction based on the fourth angular velocity and the angular velocity in the rolling direction detected by the gyroscope 502; and adjusting the roll angle of the gimbal 500 based on the angular velocity offset of the gyroscope 502 in the roll direction.

The controller 501 may adjust the roll angle of the gimbal 500 by controlling the rotation of the roll shaft motor 504.

In some embodiments, the controller 501 may be specifically used for: obtaining an actual angular velocity of the gimbal 500 in the yaw direction based on the angular velocity offset and the first angular velocity; obtaining an actual yaw angle of the gimbal 500 based on the actual angular velocity of the gimbal 500 in the yaw direction; and adjusting a yaw angle of the gimbal 500 based on a target yaw angle and the actual yaw angle of the gimbal 500, where the controller 501 adjusts the yaw angle of the gimbal 500 by controlling the rotation of the yaw axis motor 505.

In some embodiments, the controller 501 may be specifically used for: obtaining the angular velocity of the pitch axis motor 503, the angular velocity of the roll axis motor 504 and the angular velocity of the yaw axis motor 505 based on the rotation angle of the pitch axis motor 503, the rotation angle of the roll axis motor 504 and the rotation angle of the yaw axis motor 505.

In some embodiments, the controller 501 may be specifically used for: obtaining the angular velocity of the pitch axis motor 503, the angular velocity of the roll axis motor 504 and the angular velocity of the yaw axis motor 505 by differentiating the rotation angle of the pitch axis motor 503, the rotation angle of the roll axis motor 504 and the rotation angle of the yaw axis motor 505.

In some embodiments, the gimbal 500 may further include: a motor angle sensor 506; the controller 501 may be communicatively connected to the motor angle sensor 506.

The controller 501 may be further used for obtaining the rotation angle of the pitch axis motor, the rotation angle of the roll axis motor and the rotation angle of the yaw axis motor sensed by the motor angle sensors 506.

In some embodiments, the number of the motor angle sensors 506 may be three.

In some embodiments, the motor angle sensor 506 may be a Hall sensor or a potentiometer.

The gimbal in some embodiments may be used to execute the technical solutions of the above method embodiments. The implementation principles and technical effects are similar, and will not be described herein.

A person of ordinary skill in the art will appreciate that all or part of the steps to implement the above method embodiments may be completed by instructing related hardware by program. The foregoing program may be stored in a computer-readable storage medium. When the program is executed, the steps of the above method embodiments are executed. The above storage medium may include: a read-only memory (ROM), a random access memory (RAM), a magnetic disk, an optical disk, or other media for storing program code.

Finally, it should be noted that the above embodiments are only for describing the technical solutions of the present application, rather than limiting the present application. Although the present application has been described in detail with reference to the above embodiments, a person of ordinary skill in the art should understand that the technical solutions described in the above embodiments may still be modified, or some or all of the technical features may be equivalently replaced; however, these modifications or replacements do not deviate the essence of the corresponding technical solutions from the scope of the technical solutions of the embodiments of the present application.

What is claimed is:

1. A gimbal control device, comprising:
at least one storage medium, including a set of instructions for gimbal control;
at least one processor in communication with the at least one storage medium, wherein during operation, the at least one processor executes the set of instructions to:
obtain a first angular velocity of a directional device mounted on a gimbal in a first direction;
obtain at least one reference angular velocity in at least one reference direction of the gimbal;
obtain an angular velocity offset in the first direction based on the first angular velocity and the at least one reference angular velocity; and
adjust an angle of the gimbal in the first direction based on the angular velocity offset.

2. The gimbal control device according to claim 1, wherein the directional device includes a gyroscope, and
the first angular velocity includes an angular velocity detected by the gyroscope.

3. The gimbal control device according to claim 1, wherein to obtain the angular velocity offset in the first direction, the at least one processor further executes the set of instructions to:
obtain a second angular velocity by mapping one of the at least one reference angular velocity to the first direction; and
obtain the angular velocity offset in the first direction based on the first angular velocity and the second angular velocity.

4. The gimbal control device according to claim 3, wherein the first direction includes at least one of a yaw direction, a roll direction, or a pitch direction of the gimbal; and
the at least one reference angular velocity includes at least one of:
an angular velocity of a pitch axis motor, which controls a pitch angle of the gimbal,
an angular velocity of a roll axis motor, which controls a roll angle of the gimbal, or
an angular velocity of a yaw axis motor, which controls a yaw angle of the gimbal.

5. The gimbal control device according to claim 4, wherein to obtain the angular velocity offset, the at least one processor further executes the set of instructions to:
obtain the second angular velocity by mapping the angular velocity of the yaw axis motor to the yaw direction; and
obtain the angular velocity offset in the yaw direction by comparing the first angular velocity with the second angular velocity.

6. The gimbal control device according to claim 5, wherein to obtain the second angular velocity, the at least one processor further executes the set of instructions to:
obtain the second angular velocity based on a transformation matrix, and the angular velocity of the pitch axis motor, the angular velocity of the roll axis motor and the angular velocity of the yaw axis motor.

7. The gimbal control device according to claim 6, wherein to obtain the second angular velocity, the at least one processor further executes the set of instructions to:
obtain the second angular velocity by multiplying the transformation matrix by a 3*1 matrix composed of the angular velocity of the pitch axis motor, the angular velocity of the roll axis motor and the angular velocity of the yaw axis motor.

8. The gimbal control device according to claim 7, wherein prior to the obtaining of the second angular velocity by multiplying the transformation matrix by the 3*1 matrix, the at least one processor executes the set of instructions to:
determine the transformation matrix based on a rotation angle of the pitch axis motor and a rotation angle of the roll axis motor.

9. The gimbal control device according to claim 8, wherein the transformation matrix is in a form of
$$[ \begin{matrix}cosθ & 0 & - cosϕ * sin θ \\ 0 & 1 & sinϕ \\ sinθ & 0 & cosϕ * cos θ\end{matrix} ] ;$$
and
to obtain the second angular velocity by multiplying the transformation matrix by the 3*1 matrix, the at least one processor executes the set of instructions to determine the second angular velocity by multiplying [sin θ 0 cos φ*cos θ] in the transformation matrix by
$$[ \begin{matrix}A \\ B \\ C\end{matrix} ] ,$$
wherein
θ is the rotation angle of the pitch axis motor,
φ is the rotation angle of the roll axis motor,
A is the angular velocity of the pitch axis motor,
B is the angular velocity of the roll axis motor, and
C is the angular velocity of the yaw axis motor.

10. The gimbal control device according to claim 4, wherein during operation, the at least one processor further executes the set of instructions to:
determine a third angular velocity by mapping the angular velocity of the pitch axis motor to the pitch direction;
obtain an angular velocity offset in the pitch direction based on the third angular velocity and the angular velocity in the pitch direction; and
adjust a pitch angle of the gimbal based on the angular velocity offset in the pitch direction.

11. The gimbal control device according to claim 4, wherein during operation, the at least one processor further executes the set of instructions to:
determine a fourth angular velocity by mapping the angular velocity of the rolling axis motor to the rolling direction;
obtain an angular velocity offset in the rolling direction based on the fourth angular velocity and the angular velocity in the rolling direction; and
adjust a roll angle of the gimbal based on the angular velocity offset in the roll direction.

12. The gimbal control device according to claim 4, wherein to adjust the angle of the gimbal in the first direction based on the angular velocity offset, the at least one processor further executes the set of instructions to:
obtain an actual angular velocity of the gimbal in the first direction based on the angular velocity offset and the first angular velocity;
obtain an actual angle of the gimbal in the first direction based on the actual angular velocity of the gimbal in the first direction; and
adjust the angle of the gimbal in the first direction based on a target angle of the gimbal in the first direction and the actual angle of the gimbal in the first direction.

13. The gimbal control device according to claim 12, wherein during operation, the at least one processor further executes the set of instructions to:
obtain an actual angular velocity of the gimbal in the yaw direction based on the angular velocity offset and the first angular velocity;
determine an actual yaw angle of the gimbal based on the actual angular velocity of the gimbal in the yaw direction; and
adjust the yaw angle of the gimbal based on a target yaw angle and the actual yaw angle of the gimbal.

14. The gimbal control device according to claim 4, wherein during operation, the at least one processor further executes the set of instructions to:
obtain the angular velocity of the pitch axis motor, the angular velocity of the roll axis motor and the angular velocity of the yaw axis motor respectively, based on a rotation angle of the pitch axis motor, a rotation angle of the roll axis motor and a rotation angle of the yaw axis motor.

15. The gimbal control device according to claim 14, wherein to obtain the angular velocity of the pitch axis motor, the angular velocity of the roll axis motor, and the angular velocity of the yaw axis motor respectively, the at least one processor further executes the set of instructions to:
differentiate the rotation angle of the pitch axis motor, the rotation angle of the roll axis motor and the rotation angle of the yaw axis motor respectively to obtain the angular velocity of the pitch axis motor, the angular velocity of the roll axis motor and the angular velocity of the yaw axis motor.

16. The gimbal control device according to claim 14, wherein during operation, the at least one processor further executes the set of instructions to:
obtain the rotation angle of the pitch axis motor, the rotation angle of the roll axis motor and the rotation angle of the yaw axis motor sensed by motor angle sensors.

17. A gimbal, comprising:
a gyroscope;
a pitch axis motor to control a pitch angle of the gimbal;
a roll axis motor to control a roll angle of the gimbal;
a yaw axis motor to control a yaw angle of the gimbal; and
a gimbal control device communicatively connected with the gyroscope, the pitch axis motor, the roll axis motor and the yaw axis motor to:
obtain a first angular velocity detected by the gyroscope, which is an angular velocity in a yaw direction,
obtain an angular velocity of the pitch axis motor, an angular velocity of the roll axis motor and an angular velocity of the yaw axis motor,
obtain an angular velocity offset of the gyroscope in the yaw direction according to the first angular velocity, the angular velocity of the pitch axis motor, the angular velocity of the roll axis motor, and the angular velocity of the yaw axis motor, and
adjust the yaw angle of the gimbal based on the angular velocity offset.

18. The gimbal according to claim 17, wherein the gimbal control device is configured to:
obtain a second angular velocity based on the angular velocity of the pitch axis motor, the angular velocity of the roll axis motor and the angular velocity of the yaw axis motor; and
obtain the angular velocity offset in the yaw direction based on the first angular velocity and the second angular velocity.

19. The gimbal according to claim 18, wherein to obtain the second angular velocity includes to obtain the second angular velocity by mapping the angular velocity of the yaw axis motor to the yaw direction.

20. The gimbal according to claim 17, wherein the gimbal control device is further configured to:
obtain an actual angular velocity of the gimbal in the yaw direction based on the angular velocity offset and the first angular velocity;
determine an actual yaw angle of the gimbal based on the actual angular velocity of the gimbal in the yaw direction; and
adjust the yaw angle of the gimbal based on a target yaw angle and the actual yaw angle of the gimbal.
